(19) United States
(12) Patent Application Publication
(10) Pub. No.: US 2011/0028119 A1
(43) Pub. Date: Feb. 3, 2011

(54) Unique ID Based, Data File Exchange and Synchronization for Portable Communications

(75) Inventor: Dimitrios Lalos, St. Charles, IL (US)

Correspondence Address: BARNES & THORNBURG LLP, P.O. Box 2786, CHICAGO, IL, 60690-2786, US

(73) Assignee: GOEKEN GROUP CORP., Naperville, IL (US)

(21) Appl. No.: 12/811,149

(22) PCT Filed: Dec. 7, 2007
(86) PCT No.: PCT/US07/86730

§ 371 Date: Aug. 9, 2010

Related U.S. Application Data
(60) Provisional application No. 60/873,647, filed on Dec. 8, 2006.

(51) Int. Cl. H04M 3/42; H04M 11/04

(52) U.S. Cl. 455/404.1; 455/414.1

(57) ABSTRACT

The system and method for providing a data update and synchronization via a wireless system disclosed herein. The system includes a mobile transceiver assembly having an LCD and a menu navigation device, and an operations center operatively coupled to the mobile transceiver assembly via the radio frequency link. The method includes receiving a database update from the mobile transceiver assembly, detecting actuation of “edit profile” request of the mobile transceiver assembly, causing a notification signal to be transmitted to the facility controller, causing an identity and the location of the mobile transceiver assembly to be transmitted to the facility controller; and enabling a synchronized response action to be initiated by an operations center database Server located at the operations facility, thus causing the update of both databases simultaneously.

### CROSS-REFERENCE TO RELATED APPLICATIONS

This application claims priority to U.S. provisional patent application No. 60/873,647, filed Dec. 8, 2006.

### BACKGROUND OF THE INVENTION

This disclosure relates to a system and method for storage and retrieval of data and its unique relationship with a specific database existing at a particular geographic location, and more particularly to a system and method for storing and providing unique information to a subscribed service by accessing a preloaded menu directory on a portable communications device.

Intelligent mobile transceiver devices utilizing one of any number of radio frequency links are well known in the art. Mobile transceiver assemblies typically transmit and receive via a radio network that may include a number of fixed base stations with antennas, one or more mobile switching center(s), PSTNs and/or satellites. The radio network may also include one or more links to the Internet, to a local area network (LAN) and/or to a wide area network (WAN). Most of these intelligent devices utilize menu driven applications preloaded at the OEM factory or wireless provider locations.

In most cases however, the mobile transceiver assembly may include a menu directory for navigation to specific features and services. Such a directory is typically enabled via the use of a keypad in the mobile transceiver assembly and menu navigation direction is provided via an LCD screen.

Mobile transceiver assemblies having interactive capability to access external databases and features may be configured to gain access to a variety of services, including, for example, telephone directories and address books, calendars, Internet Browsers, Clocks, System specific information, games, calculators, stored pictures, Search & Help functions, to name a few.

In some applications such as Internet Browser service, the assembly would automatically access the Internet and the user is able to access the information he is looking for in a similar fashion as landline applications. Unfortunately, if the person operating the portable assembly, would like to remotely instruct the service to perform a complex function i.e. transact a complex data exchange (command) for data to be forwarded to another remote location such an operation is very cumbersome and involves the participation of multiple “clearing” operations thus does not provide for expeditious transactions or for an adequate response to the needs of the operator.

### SUMMARY OF THE INVENTION

The system and method for storage and retrieval of data and its unique relationship with a specific database existing at a specific geographic location, and more particularly to a system and method for storing and providing unique information by accessing a preloaded by the individual or the wireless provider menu directory on a portable communications device disclosed herein improves on the prior art in a number of ways. In addition to accessing, manipulating, updating and storing information, it generally enables transmission of audio, audible, or text information, in real time, to a registered user of the mobile transceiver assembly (“the registered user”). Moreover, it enables quick access to personal information/data specific to the registered user, and using that information, allows a remote operations Center to respond more efficiently. It also allows responders or others having the registered user's information to communicate with the registered user via the mobile transceiver assembly. Accordingly, the system and method for storage and retrieval of data and its unique relationship with a specific database existing at a specific geographic location, and more particularly to a system and method for providing assistance by accessing a menu directory on a portable communications device enables new and updated information to be forwarded to the registered user or the remote Operations Center quickly and effectively.

A system and a method where Internet based unique data gathered and stored as well as unique pictorials are downloaded via the portable's data port or over the air (wireless) after such individual has registered with the Service Provider and has received a Unique ID from that Provider, associated with the said Service offering.

Preferably, there are one or more direct and secure data connections via the Internet to the Service Provider's Data Servers.

According to a first aspect of the invention, there is disclosed a system and method for storage and retrieval of data and its unique relationship with a specific database. Unique updates and edits can be accomplished via the 1) wire line communications 2) an Internet connection to a specific Internet link or 3) a wireless system comprising: a mobile transceiver assembly that includes a radio network transceiver configured to receive and transmit radio frequency signals via a radio frequency link, and a mobile transceiver assembly controller operatively coupled to the radio network transceiver, the LCD screen, and a keypad for information entry; and an operations center operatively coupled to the mobile transceiver assembly via the radio frequency link where the operations center includes a database processing facility having a data storage device and a facility controller where the data storage device stores personal data associated with the registered user of the mobile transceiver assembly and where the facility controller is adapted to retrieve the personal data of the registered user in response to receipt of unique transceiver identification number, an integrated phone-computer terminal operatively coupled to the facility controller, where the integrated phone-computer terminal is adapted to enable an operations center attendant to initiate a response action as a result of a notification signal, and a communication interface operatively coupled to the data processing facility and the integrated phone-computer terminal where the communication interface is adapted to enable communication between the integrated phone-computer terminal and the mobile transceiver assembly.

Preferably, the mobile transceiver assembly further includes a keypad, a speaker, a microphone, an LCD color or monochrome display, and a battery.

Conveniently, the notification signal includes a security identity linked to the specific database as well as the mobile transceiver assembly, and the personal data includes the registered user's identity and vital data.

According to a second aspect of the invention, there is disclosed a method for providing a unique data update via a wireless system where the wireless system includes a mobile transceiver assembly operatively coupled to an operations center via a radio frequency link and the Operations Center is operatively coupled to a specific Data Server(s) where the unique ID's and subscriber unique data are kept, and where the mobile transceiver assembly includes a mobile transceiver assembly controller, the method comprising: navigating via a menu on the mobile transceiver assembly via the LCD of the mobile transceiver assembly; detecting unique data changes on the file associated with the specific menu subdirectory of the mobile transceiver assembly; causing a new file to be generated within the newly created profile on both the portable device and the Operation Center where the main database exists in response to the newly stored data; in response to a data poll, causing an identity of the mobile transceiver assembly to be transmitted to the operations center; and enabling a full duplex communication link to be established between the mobile transceiver assembly and an integrated phone-computer terminal of the operations center in response to menu driven data change action initiated by the portable's owner or an operations center attendant located at the integrated phone-computer terminal where the full duplex communication link allows communication between a registered and uniquely identified user of the mobile transceiver assembly, the operations center attendant and/or the secure Data Server(s) where all the unique ID's and profiles are kept.

Conveniently, the step of enabling a full duplex communication link to be established between the mobile transceiver assembly and the integrated phone-computer terminal of the operations center and eventually the update of the uniquely identified person's profile in response to a data field change includes positive confirmation on the data change(s) of the mobile transceiver specific menu information; enabling positive response from the operations center attendant and/or the secure Data Server to be displayed to the registered user via a display device of the mobile transceiver assembly in response to the newly stored data action.

Preferably, the step of causing the confirmation notification signal to be transmitted to the operations center includes causing a radio network transceiver of the mobile transceiver assembly to change its menu subdirectory.

Advantageously, the step of retrieving identity data associated with the registered user includes retrieving identity data from a data storage device coupled to the facility controller, and the step of receiving the identity of the mobile transceiver assembly includes receiving the identity from a radio network receiver of the mobile transceiver assembly.

Other objects, advantages and novel features of the present disclosure will become apparent from the following detailed description when considered in conjunction with the accompanying drawings.

### BRIEF DESCRIPTION OF THE DRAWINGS

FIG. 1 is a functional block diagram of a wireless system for a system and method for storing and providing unique information to a subscribed service by accessing a preloaded menu directory on a portable communications device according to an embodiment of the invention;

FIG. 2 is a functional block diagram of an exemplary screen sequence for Voice communication updates;

FIG. 3 is a functional block diagram of an exemplary screen sequence for Data communication updates.

FIG. 4 is a functional block diagram of an exemplary screen sequence for a functional application provider.

### DETAILED DESCRIPTION

Throughout the description, identical reference numbers are used to identify like parts.

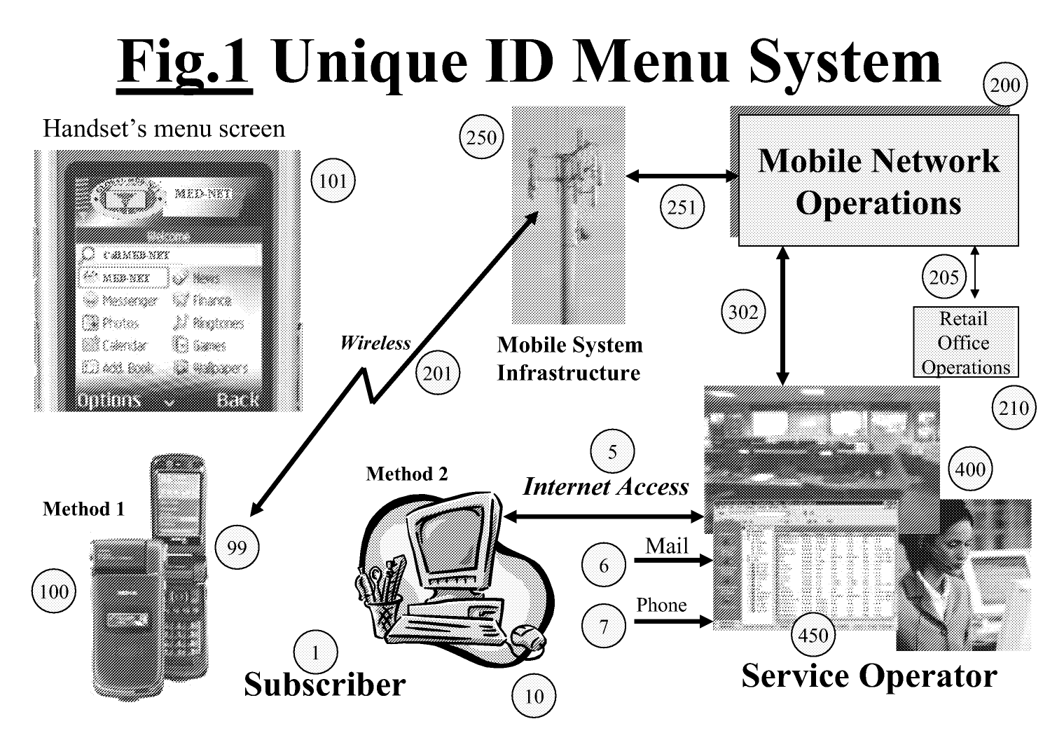

FIG. 1 is a functional block diagram of an exemplary communications system and method for storage and retrieval of data and its unique relationship with a specific database 450 existing at a specific geographic location 400, and more particularly to a system and method for storing and providing unique information by accessing a preloaded by the individual or the wireless provider menu directory on a portable communications device according to an embodiment of the invention. The communications system includes, a given subscriber 1 having access to a computer terminal 10 that is connected to the Internet 5 that is able to access a specific Web address and input specific information to a maintained and updated database 450. A portable communications device 100, such as a wireless handset, that has a menu 101 displayed. Said portable device 100 is wirelessly connected to a wireless network 201 via a network infrastructure 250 architecture. Mobile system infrastructure 250 is connected to a Mobile Network Operations infrastructure 200 where network logistics and call forwarding occurs. Infrastructure 200 is capable in supporting incoming and outgoing calls originated worldwide.

As such, infrastructure 200 is connected to Retail Office Operations Network 210 via link 205. Link 205 functions as the programming link for newly introduced subscribers into the network. Mobile Network Operations 200 is also connected (direct or dial-up) via Link 302 to a Unique Service Operator 400.

Unique Service Operator 400 is capable of servicing calls and data transactions associated with its customers or subscribers as logged-in and listed on the communications Server(s) maintaining database 450.

As such communications Servers and database 450 are accessible via secured link(s) 5 accessed via the Internet from any worldwide location.

The integrated phone-computer terminal at location 400 provides both telephone and computer functionality. Accordingly, the integrated phone-computer terminal may have one of any number of configurations including, for example, a smart-phone with a suitable display, or a telephone coupled to a computer having a display. In cases where more than one integrated phone-computer terminal is utilized, the integrated phone-computer terminals may be arranged in a network using one of many well-known methods (e.g., using an Ethernet LAN arrangement). This functionality would service direct access to an operator via the telephone for manual update of database 450 assuming the proper identification requirements are fulfilled.

As illustrated by FIG. 1, the communication interface 450 is configured to enable wireless or wired transmission/receipt to and from a wireless subscriber 1 from his portable device 100 or via Internet computer connection 10.

The system may support several entry points for data gathering and from any computing device(s) such as 10 or 100. For example, subscriber 1 enters subscription to a unique service offered by Service Operator 400. Subscription can be gained either by visiting a Retail Office 210, by mail 6, by phone 7 or via the Service Operator's Web site 5. As a result of such a transaction subscriber is issued a unique ID 150 and a unique file is created on database 450.

The database processing facility 400 includes a data storage server 450 arranged on a networking architecture thus allowing for multiple Operator locations to access the data simultaneously. The data storage server 450 is configured to store personal data associated with one or more registered users of the mobile transceiver assembly(s) 100. The personal data may include, for example, the identity of the registered user, medical data associated with the registered user, medical personnel preferences of the registered user, drug allergies, next of kin data, etc. As such database 450 can be updated simultaneously from subscriber 1 itself, via portable unit 100 using portable unit's unique ID 99 and unique ID 150 as shown below or via the Internet 10 using unique ID 150. Alternatively, database 450 could be accessed via an operator at Service Operator's location given the unique ID 150 is provided and other security questions are answered.

Although not separately shown in detail, the database 450 is operated via a server computer that includes at least a processor and a memory bank. The server computer controls various operations of the operations center 400 that represents a number of portions or routines of one or more computer programs.

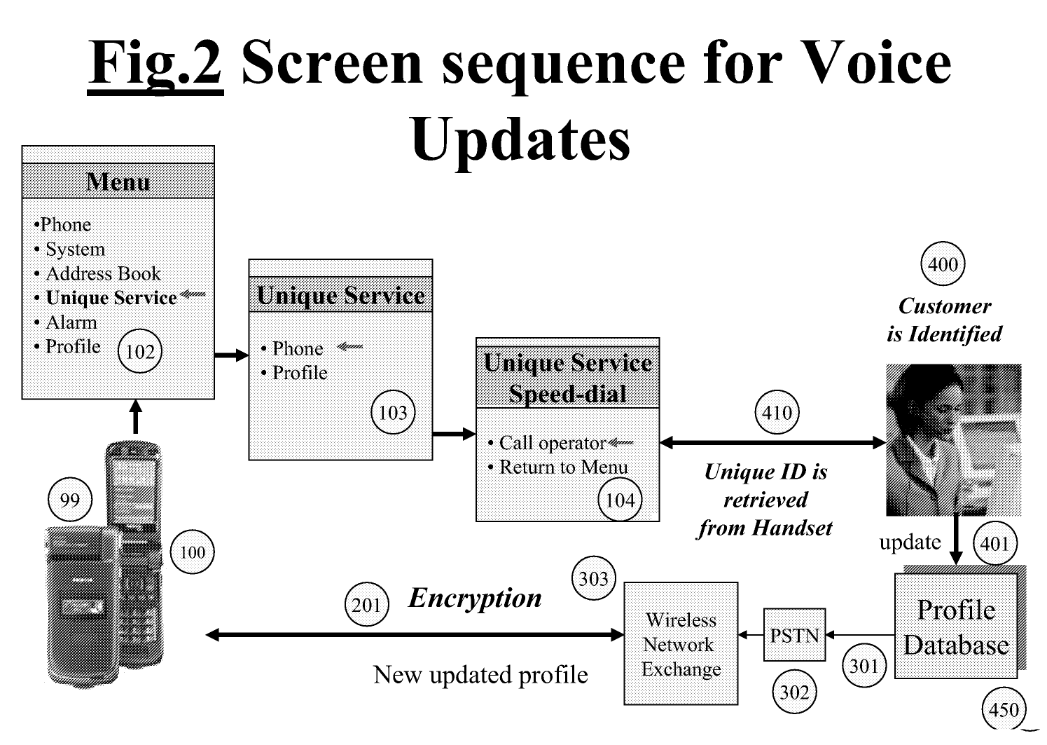

FIG. 2 is a more detailed functional block diagram of the mobile transceiver's menu assuming the subscriber chooses to utilize the Voice function as mentioned in connection with FIG. 1. For example, subscriber would like to access the unique service menu by depressing “Unique Service” via the keypad. The LCD screen would change to another menu asking the subscriber to either use the function of phone (voice) or manipulate (edit) the profile information himself. On the next menu function upon prompting of “call operator” a pre-programmed speed dial number 410 is dialed and a live operator is accessed from Customer Center 400. Unit and subscriber are identified via the unique ID 99 stored in the handset 100. At that point subscriber 1 via live operator help updates database 450.

Referring to FIG. 2, it is apparent that a given profile update needs to be also uploaded 201 into the handset 100 so subscriber information 400 exists in both domains and it is kept up to date.

As such, profile database 450 via a communications link 301 accesses the PSTN 302 that in turn dials and accesses the wireless network exchange 303 that subscriber 1 is registered with. Via an encrypted link 201, new and updated profile is transmitted and synchronized to portable assembly 100.

The mobile transceiver assembly may include a program memory (including a read only memory (ROM)), a microcontroller-based platform or microprocessor (MP), a random-access memory (RAM) and an input/output (I/O) circuit, all of which may be interconnected via a communications link, or an address/data bus.

The microprocessor is capable of, among other things, detecting new file arrival, causing a response signal to be generated. A synchronization command would be issued at this point enabling the communications link to be completed to the operations center 400. It is understood that the program memory is capable of storing program code that, among other things, controls operation of the mobile transceiver assembly 100. For example, based on detecting complete synchronization of the data and data transfer completion, it notifies the subscriber that such update has been accomplished.

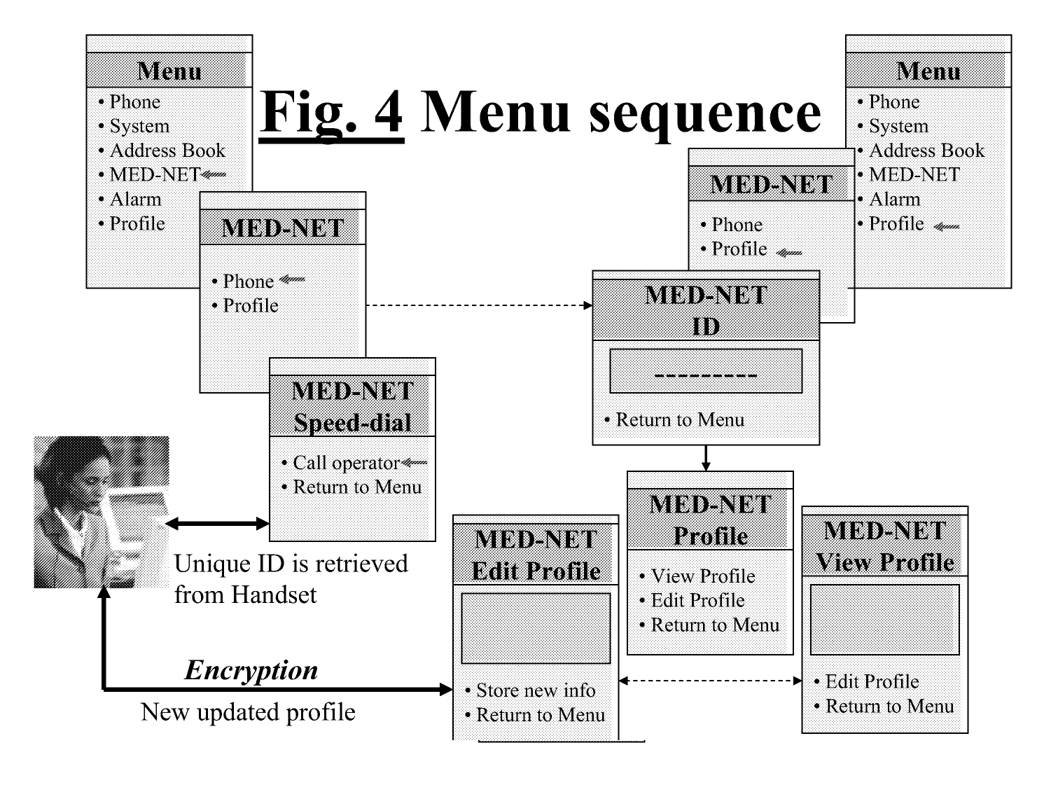

One manner in which the system may operate is described below in connection with a flowchart (see, FIG. 4) that represents a number of portions or routines of one or more computer programs, which may be stored in one or more of the memories of the profile database 450 and/or the mobile transceiver 100. The computer program(s) or portions thereof may also be stored remotely, outside of the wireless system and may therefore control the operation from a remote location.

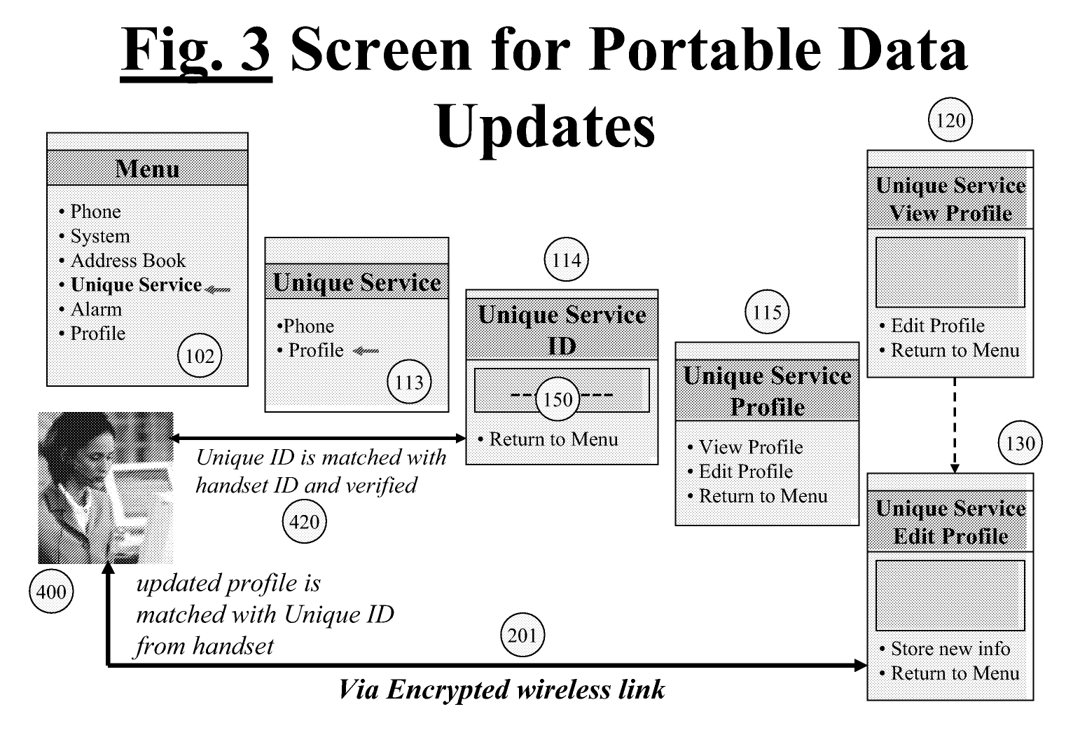

FIG. 3 is a more detailed functional block diagram of the mobile transceiver's menu assuming the subscriber chooses to utilize the portable's data update function as mentioned in connection with FIG. 1. Referring to FIG. 3, for example, subscriber would like to access the unique service menu by depressing “Unique Service” via the keypad. The LCD screen would change to another menu asking the subscriber to either use the function of phone (voice) or manipulate (edit) the profile information himself. Upon choosing the profile function 113 user would be asked to input the Unique Service ID number on screen 114. Unique Service ID number is the number issued to the user at the time of enrollment into the Service.

Upon verification 420 of the Unique Service ID by the Operations Center 400, user is allowed to navigate into the next menu 115.

At this point the user is given several options. If user chooses to view his profile the currently “stored” profile 120 is displayed. In the event user desires to update some data on his profile he would proceed to menu 130 where the information could be changed and updated. Upon completion of the data manipulation and editing user is capable of storing the newly created profile securely (via a encrypted link 201) update his profile at the database server 450.

It is important to notice that such operation would only be valid if the profile of the user is uniquely matched with the handset's ID and the Unique Service ID as explained above. A verification message that such operation is completed and verified would be generated at the portable device.

As may be apparent from the above discussion, that the communications system and method for storage and retrieval of data and its unique relationship with a specific database existing at a specific geographic location, and more particularly to a system and method for storing and providing unique information by accessing a preloaded by the individual or the wireless provider menu directory on a portable communications device disclosed herein enables a registered user of a mobile transceiver assembly to easily change its information profile with updated information. It may be also apparent that the system utilizes a unique ID coding sequence to validate and positively identify the subscriber and the portable unit in association with the unique user profile stored at an external database. In addition to changing information on a real time basis, the system and method for providing a data synchronization via a wireless system generally enables transmission of data, in real time, to both the user and the database management access point via a secure and encrypted link. In a particular application, it enables quick access to medical and other personal information/data specific to the registered user, and using that information, allows the emergency responders to respond more efficiently. Accordingly, the system and method for providing an emergency response via a wireless system enables data to be transmitted to the registered user quickly and effectively.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicant has provided description and figures which are intended as illustrations of embodiments of the disclosure, and are not intended to be construed as containing or implying limitation of the disclosure to those embodiments.

1. A system for submitting vital information to an independent mobile services provider, the system comprising:
a) a mobile transceiver assembly
b) an independent to mobile operator, operations center and
Submitting data system comprising:
a) the Internet, with access to the mobile services provider specific web page
b) Live Operator with access to an integrated phone-computer terminal
c) The Postal Service for pre-printed forms associated with the person's unique and vital data

2. A system of claim 1 for updating and synchronizing data between a portable device and a remotely based database, the system comprising:
a) a mobile transceiver assembly including:
a radio network transceiver configured to receive and transmit radio frequency signals via a the radio frequency link,
a LCD display configured to display a menu structure,
a keypad acting as a navigation device in association to the LCD display, and
a mobile transceiver assembly controller operatively coupled to the radio network transceiver, the LCD display, and the keypad, the mobile transceiver assembly controller including a processor and a memory operatively coupled to the processor of the mobile transceiver assembly controller; and
b) an operations center operatively coupled to the mobile transceiver assembly via the radio frequency link, the operation center including:
a database processing facility including a data storage device and a facility controller operatively coupled to the data storage device, the data storage device storing personal data associated with the registered user of the mobile transceiver assembly, the facility controller including a processor and a memory operatively coupled to the processor of the facility controller, the facility controller adapted to retrieve the personal data of the registered user in response to receipt of the data change request,
an integrated phone-computer terminal operatively coupled to the facility controller, the integrated phone-computer terminal adapted to enable an operations center attendant to initiate a data inquiry and update in response to receipt of an electronic or personal request associated with a unique identification code issued upon subscription initiation, and
a communication interface operatively coupled to the data processing facility and the integrated phone-computer terminal, the communication interface adapted to enable communication and synchronization of data between the integrated phone-computer terminal and the mobile transceiver assembly.

3. The system of claim 2, further comprising an external database operatively coupled to the facility controller, the external database configured to store personal data associated with a plurality of registered users.

4. The system of claim 2, wherein the mobile transceiver assembly further comprises:
a keypad coupled to the mobile transceiver assembly controller and adapted to enable the registered user to textually communicate with the external database;
a display device coupled to the mobile transceiver assembly and adapted to display instructions and navigation information to update the data stored in the mobile transceiver assembly.

5. The system of claim 2, wherein the personal data includes registered user unique identity number and vital data.

6. The system of claim 2, wherein the change of data notification signal includes a specific identity number of the mobile transceiver assembly.

7. The system of claim 2, wherein the data change could occur via voice communications with the operations center attendant.

8. The system of claim 2, wherein the data synchronization and update action causes the LCD display to notify the user of the changes.

9. The system of claim 2, wherein the user is required to input the unique person identification number for verification purposes.

10. The system of claim 2, where the system matches the unique identification number before proceeding to the next step of operation.

11. The system of claim 2, where the system operations attendant matches the unique handset identification and the unique person identification number before proceeding to the next step of operation.

12. A method for providing a database update and synchronization via a wireless system, the wireless system including a mobile transceiver assembly operatively coupled to an operations center via a radio frequency link, the mobile transceiver assembly including a mobile transceiver assembly controller, the method comprising:
receiving a data inquiry from the mobile transceiver assembly;
detecting request for a database of the mobile transceiver assembly;
causing a request to be transmitted to the operations center in response to the actuation;
in response to a data poll, causing an identity of the mobile transceiver assembly to be transmitted to the operations center; and
enabling a full duplex communication link to be established between the mobile transceiver assembly and an integrated phone-computer terminal of the operations center in response to an emergency response action initiated by an operations center attendant located at the integrated phone-computer terminal, the full duplex communication link allowing data or voice communication between a uniquely identified registered user of the mobile transceiver assembly and the operations center attendant.

13. The method of claim 12, further comprising enabling a menu change on the LCD of the mobile transceiver assembly.

14. The method of claim 12, further comprising enabling navigation instruction from the operations center database server to be displayed to the uniquely identified registered user via a display device of the mobile transceiver assembly.

15. The method of claim 12, wherein causing the database change to be transmitted to the operations center includes causing a radio network transceiver of the mobile transceiver assembly to transmit the data change notification signal.

16. The method of claim 12, wherein receiving the data change request from the mobile transceiver assembly includes receiving the unique person identification number, receiver operatively coupled to the mobile transceiver assembly controller.

17. The method of claim 12, wherein the mobile transceiver assembly controller includes a processor and a memory operatively coupled to the processor of the mobile transceiver assembly.

18. A method for providing a data base and synchronization via a wireless system, the wireless system including a mobile transceiver assembly operatively coupled to an operations center via a radio frequency link, the mobile transceiver assembly including a mobile transceiver assembly controller, the operations center including a facility controller, the method comprising:
receiving a data change request notification signal from the mobile transceiver assembly;
transmitting a data poll to the mobile transceiver assembly requesting a unique identity and a unique person identity number of the mobile transceiver assembly;
receiving the identity and unique person identity number of the mobile transceiver assembly and subscriber;
based on the identity of the mobile transceiver assembly and unique person identification number, retrieving identity and vital data associated with a registered user of the mobile transceiver assembly; and
causing the identity and eventually the vital data to be transmitted to an integrated phone-computer terminal of the operations center.

19. The method of claim 18, further comprising:
synchronizing the data between the mobile transceiver assembly and the remotely located database; and
causing the database update to the last information entered and positively verified.

20. The method of claim 18, further comprising establishing a full duplex communication link between the mobile transceiver assembly and the integrated phone-computer terminal in response to a database change initiated by an operations center attendant located at the integrated phone-computer terminal, the full duplex communication link allowing data exchange between the registered user of the mobile transceiver assembly and the operations center database Server.

21. The method of claim 20, further comprising causing an LCD display instruction from the operations center database Server to be displayed to the registered user mobile transceiver assembly.

22. The method of claim 20, wherein retrieving identity and vital data associated with the registered user includes retrieving identity and vital data from a data storage device coupled to the facility controller.
